(19) United States
(12) Patent Application Publication
(10) Pub. No.: US 2005/0251375 A1
(43) Pub. Date: Nov. 10, 2005

(54) Method for simulating the dynamics of biological networks in silico

(76) Inventors: Lukasz Salwinski, Los Angeles, CA (US); David Eisenberg, Los Angeles, CA (US)

Correspondence Address: NEEDLE & ROSENBERG, P.C., SUITE 1000, 999 PEACHTREE STREET, ATLANTA, GA, 30309-3915, US

(21) Appl. No.: 11/123,846

(22) Filed: May 6, 2005

Related U.S. Application Data
(60) Provisional application No. 60/568,885, filed on May 7, 2004.

(51) Int. Cl. G06G 7/48; G06G 7/58

(52) U.S. Cl. 703/11; 703/12

(57) ABSTRACT

A stochastic simulation method for simulating the kinetics of chemical networks implemented using reprogrammable Field Programmable Gate Array (FPGA) devices. Such devices, built as an array of simple configurable logic blocks embedded in a programmable interconnection matrix, implement highly parallel architectures comparable in complexity to biochemical networks. Circuits based on FPGAs scale efficiently so that simulations of realistic biological systems are possible.

### CROSS REFERENCE TO RELATED PATENT APPLICATION

This application claims priority to U.S. Provisional Application No. 60/568,885 filed May 7, 2004, and which is herein incorporated by reference in its entirety under 35 U.S.C. § 120.

### ACKNOWLEDGEMENTS

This invention was made with Government support under Grants No. FC03-02ER63421 awarded by the DOE. The Government has certain rights in the invention.

### BACKGROUND OF THE INVENTION

Realistic simulation of biological networks requires stochastic simulation because of the small number of molecules in cells. The high computational cost of stochastic simulation on conventional microprocessor-based computers arises from the intrinsic disparity between the sequential steps executed by a microprocessor program and the highly parallel nature of information flow within biochemical networks. This disparity is reduced with the Field Programmable Gate Array (FPGA)-based approach presented here.

Biological systems are made up of thousands of simple elements linked together to form complex networks capable of adopting to diverse stimuli. The elements of those networks are molecules and molecular complexes within a cell. They perform simple tasks, such as amplification or integration of a signal, whereas the complexity of the response emerges from the structure and dynamics of the entire network. To understand and predict the behavior of such networks under a realistic variety of external stimuli, efficient algorithms for simulation are required because the kinetics of all but trivial biochemical networks cannot be described analytically. Moreover, because of the low abundance of some molecules within cells, Monte Carlo simulation methods must be used to capture the stochastic behavior of the system.

Exact Monte Carlo methods, pioneered nearly three decades ago and subsequently improved have been applied successfully to simulations of small biological networks. However, simulation of larger networks approaching the size of those describing the behavior of entire cells has not yet been possible both because of limited experimental data and also because of the high computational demands of the conventional stochastic algorithms, which scale at best as O(n log n) with the network size. With the rise of various ‘omics’ approaches, the limitation of experimental data is being lifted, but the computational demands remain staggering for simulating networks of thousands of reactions involving thousands of reactants. The problem stems from the intrinsic disparity between the sequential nature of microprocessor architecture and the highly parallel nature of biological systems, with the result that simulation times become prohibitively long.

Here we demonstrate that a stochastic simulation algorithm that can be efficiently implemented using reprogrammable Field Programmable Gate Array (FPGA) devices to build a microelectronic circuit that simulates the kinetics of chemical networks. Such devices, built as an array of simple configurable logic blocks embedded in a programmable interconnection matrix, are ideally suited to implement highly parallel architectures comparable in complexity to biochemical networks. Circuits based on FPGAs scale efficiently so that simulations of realistic biological systems are possible.

### SUMMARY OF THE INVENTION

A method of simulating the kinetics of a chemical reaction describing at least one product and at least one substrate, the reaction having a reaction specific rate constant with an associated time factor, comprising: converting a chemical reaction simulation model described in a hardware description language into at least one binary file; downloading the at least one binary file to an at least one logic chip wherein each substrate, product, reaction specific rate constant, and time factor of the chemical reaction are represented by registers having a value; and tracking values of at least one of the registers over time wherein the registers are altered if the reaction occurs.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate (one) several embodiment(s) of the invention and together with the description, serve to explain the principles of the invention.

FIG. 1 is a block diagram illustrating an exemplary two way chemical reaction simulation system.

FIG. 2 is a block diagram illustrating an exemplary time optimized simulation system.

FIG. 3 A, B, and C is a schematic diagram illustrating exemplary logic blocks of the system.

FIG. 4 A and B illustrate an exemplary logic block system for simulating an elementary bimolecular reaction and resulting trace data graph.

FIG. 5 A and B illustrates resulting trace data graphs generated by an FPGA circuit simulating simple Michaelis-Menten kinetics of enzymatic reaction.

FIG. 6 A and B illustrates resulting trace data graphs generated by an FGPA circuit simulating lacZ gene expression.

FIG. 7 illustrates the steps of the method.

### DETAILED DESCRIPTION OF THE INVENTION

The present invention may be understood more readily by reference to the following detailed description of preferred embodiments of the invention and the Examples included therein and to the Figures and their previous and following description.

Before the present compounds, compositions, articles, devices, and/or methods are disclosed and described, it is to be understood that this invention is not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a logic chip” includes mixtures of logic chips, reference to “a logic chip” includes mixtures of two or more such logic chips, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. For example, the phrase “optionally substituted registers” means that registers may or may not be substituted and that the description includes both unsubstituted registers and registers where there is substitution.

In this specification and in the claims which follow, reference will be made to a number of terms which shall be defined to have the following meanings:

“Reaction” is defined as the chemical interaction of molecules to form new molecules. An example includes, but is not limited to, reaction between carbon dioxide (CO₂) and water (H₂O) in which carbonic acid is formed: CO₂+H₂O→H₂CO₃

“Reactive event” is defined as an event in which individual substrate molecules are converted to product molecules. As the result the number of substrate molecules is depleted by one and the number of product molecules is increased by one. An example includes, but is not limited to, a reactive event in which molecule of water reacts with a molecule of carbon dioxide to form a molecule of carbonic acid.

“Substrate” is defined as molecules that react to create a product molecule. When reference is made to a substrate, that reference can include molecules on both sides of a two way chemical reaction, thereby classifying a molecule as both product and substrate. An example includes, but is not limited to, CO₂ and H₂O molecules in the reaction above.

“Product” is defined as molecules that are created as the result of substrate molecule reaction. An example includes, but is not limited to, H₂CO₃ molecules in the reaction above.

“Forward reaction” is defined as, in reaction notation, a reaction that moves from left to right wherein the substrates are on the left side of the notation and the products are on the right side of the notation. An example includes, but is not limited to, CO₂+H₂O→H₂CO₃.

“Reverse reaction” is defined as, in reaction notation, a reaction that moves from right to left wherein the substrates are on the right side of the notation and the products are on the left side of the notation. An example includes, but is not limited to, CO₂+H₂O←H₂CO₃.

“Two way reaction” is defined as a reaction that, in reaction notation, can move from left to right, or from right to left. The molecules on either side are both substrates and products. An example includes, but is not limited to, CO₂+H₂O⇄H₂CO₃.

“Time step” is defined as period of time for which progression of the reaction is simulated.

“Digital circuit” is defined as an electric circuit that uses a number of discrete voltage levels to represent logic levels or numbers. In most cases there are two voltage levels. Examples include, but are not limited to, logic gates and flip-flops implemented in technologies such as TTL or CMOS.

“Asynchronous (or combinatorial) digital circuit” is a digital circuit that changes it state at the moment when its inputs changes value. An example includes, but is not limited to, logic gates.

“Synchronous digital circuit” is a digital circuit that changes it state at the moment when its specific input (called “clock”) changes value. An example includes, but is not limited to, flip-flops.

“Logic chip” is defined as a type of digital circuit that performs logical and/or mathematical operations. Examples include, but are not limited to, Field Programmable Gate Arrays (FPGA), Programmable Logic Devices (PLD), and Application-Specific Integrated Circuit (ASIC).

“Clock cycle”, is defined as the period of time it takes a synchronous digital circuit to update its state. Examples include, but are not limited to, the period of time it takes a flip-flop to update its state.

“Register” is defined as a set of flip-flops that can either hold a value.

“Counter” is a type of digital circuit, typically composed of a set of flip-flops and combinatorial elements that (besides storing a value) can increment or decrement the stored value (typically, but not necessarily) by 1.

“Random number generator” (RNG), also referred to herein as number generator, is defined as a computational or physical device designed to generate a sequence of numbers that does not have any easily discernable pattern, so that the sequence can be treated as being random. RNGs generate a series of N-bit numbers (where N is the width of the register/memory the number is compared to) that have a uniform distribution (i.e., the probability of generating each possible number is the same). However, RNG can draw samples from other distributions (Gaussian, Poisson, etc). The present systems can use pseudo-random number generators (PRNG) which are a sub-class of RNG in that they generate a predictable series of numbers, otherwise characterized as in the definition above.

Reference will now be made in detail to the present aspects of the invention, example) of which are illustrated in the accompanying drawings. Wherever possible, the same reference numbers are used throughout the drawings to refer to the same or like parts.

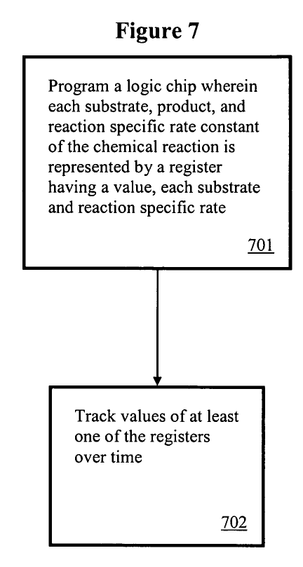

FIG. 7 illustrates generally, the steps involved in the disclosed method of simulating the kinetics of a chemical reaction where the chemical reaction has at least one substrate, product, and reaction specific rate constant. The first step, indicated as block 701, can comprise programming a logic chip wherein each substrate, product, and reaction specific rate constant of the chemical reaction is represented by a register having a value, each substrate and reaction specific rate. The next step, indicated as block 702, can comprise tracking the values of at least one of the registers over time.

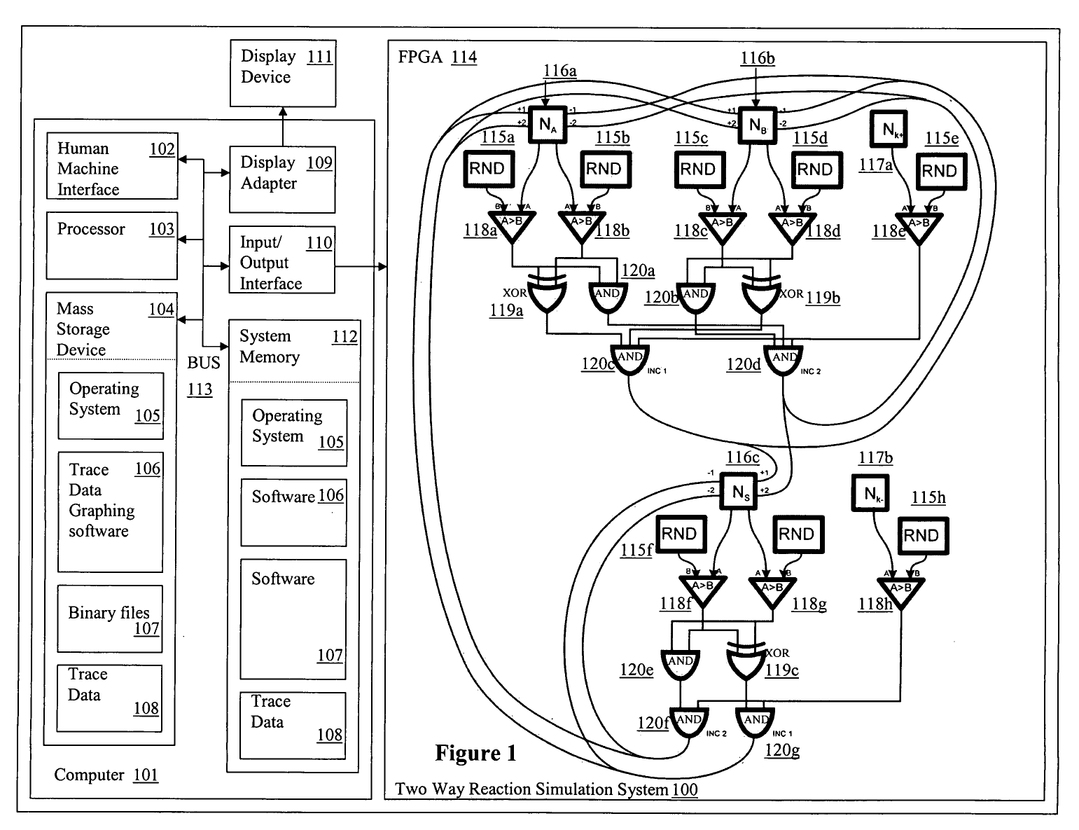

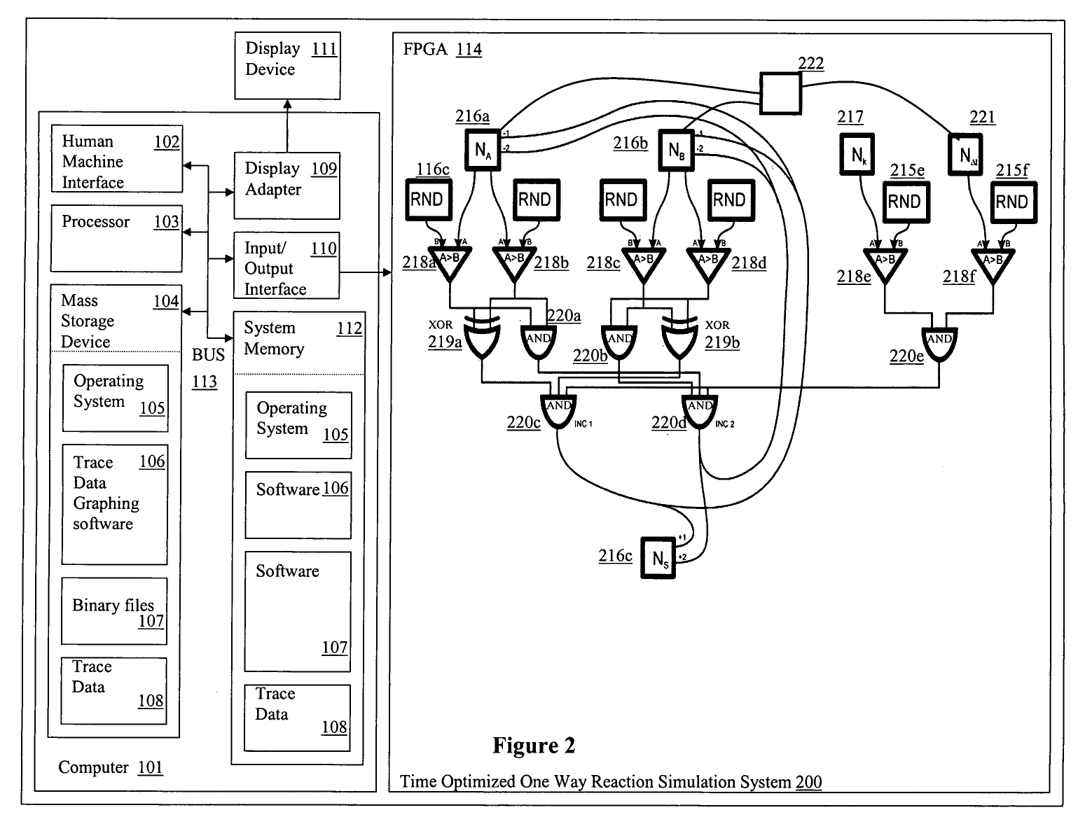

Exemplary systems implementing the method are shown in FIG. 1 and FIG. 2. The system comprises a logic chip, which can be an FPGA or similar device. The logic chip in FIG. 1 simulates the chemical reaction
A+B⇄S
While the logic chip in FIG. 2 simulates the chemical reaction
A+B→S
A logic chip of the exemplary systems can comprise N_{A}, N_{B} and N_{S} counters that store the number of molecules of each species as well as of a set of comparators and pseudo-random number generators (RND) that, in the exemplary system are constructed out of linear feedback shift register (LFSR). Every clock cycle, the RND's and comparators can be used to draw a sample from a random variable distribution that reflects the probability of the reaction progressing by one reactive event in a specified, discrete time interval. Networks of coupled reactions can be simulated by combining these building blocks into larger logic chips with up to about 500 reactions fitting into a single, commercially available, integrated circuit. Larger systems can be simulated by partitioning the design between several logic chips incorporated into a single system.

When two or more reactions involving a particular reactive species are to progress concurrently within the same time step, additional control circuitry can be used to resolve conflicts that arise. Reactions can progress when the net change of the number of the molecules of interest is one or two; otherwise the progression of all the reactions changing the abundance of this molecule is cancelled.

The size of the discrete time step is a key parameter that determines the speed of the simulation. It is limited by both the maximum expected probability of the cancellations mentioned above and by the rate of the fastest reaction within the simulated system. The expected probability of cancellations, p_{cancel}, is equal to a product:
p_{cancel}=p_{R1}·p_{R2}
where p_{R1} and p_{R2} are the probabilities that two competing reactions R1 and R2 advance within the same time step. These probabilities can be controlled by adjusting the time step. The rate of the fastest reaction requires the time step to be adjusted so that the probability of more than a single pair of molecules reacting is small compared to the probability of a single pair reacting once or twice, p_{R}. The upper limit of this difference Δp_{R} can be estimated as:

$$Δ {p}_{R} = \frac{{p}_{R}}{{( 1 - {p}_{R} )}^{2}} - {p}_{R}$$

and can be controlled by choice of time step size. Setting the time interval so that the max(p_{R})<0.01, limits both p_{cancel} and Δp_{R} to less than 1% of p_{R} for the fastest reaction and to correspondingly less for all other reactions.

Once the logic chip is programmed and the counters loaded with the initial values, the state of the entire system can be updated every cycle of the system clock, running at frequencies on the order of about 100 MHz. Different frequencies can be used as known to one skilled in the art. Although slower than the clocks running currently available microprocessors, the massively parallel architecture of the logic chip-based system can result in simulation rates at least an order of magnitude higher than conventional microprocessor-based systems implementing the Gillespie algorithm.

FIG. 1 is a block diagram illustrating an exemplary system 100 for performing the disclosed simulation methods. FIG. 2 is a block diagram illustrating an alternative exemplary system 200 for performing the disclosed simulation methods. These exemplary simulation systems are only examples of simulation systems and are not intended to suggest any limitation as to the scope of use or functionality of simulation architecture. Neither should the simulation systems be interpreted as having any dependency or requirement relating to any one or combination of components illustrated in the exemplary simulation systems.

The exemplary simulation systems of FIGS. 1 and 2, 100 and 200 respectively, include a general-purpose computing device in the form of a computer 101. The components of the computer 101 can include, but are not limited to, one or more processors or processing units 103, a system memory 112, and a system bus 113 that couples various system components including the processor 103 to the system memory 112.

The system bus 113 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 113, and all buses specified in this description can also be implemented over a wired or wireless network connection and each of the subsystems, including the processor 103, a mass storage device 104, an operating system 105, a trace data graphing software 106, binary files 107, trace data 108, the system memory 112, an Input/Output Interface 110, a display adapter 109, a display device 111, and a human machine interface 102, can be contained within one or more remote computers (not shown) at physically separate locations, connected through buses of this form, in effect implementing a fully distributed system.

The computer 101 typically includes a variety of computer readable media. Such media can be any available media that is accessible by the computer 101 and includes both volatile and non-volatile media, removable and non-removable media.

The system memory 112 includes computer readable media in the form of volatile memory, such as random access memory (RAM), and/or non-volatile memory, such as read only memory (ROM). The system memory 112 typically contains data such as binary files 107 and trace data 108 and/or program modules such as operating system 105 and trace data graphing software 106 that are immediately accessible to and/or are presently operated on by the processing unit 103.

The computer 101 may also include other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 104, including by way of example, an operating system 105, trace data graphing software 106, and trace data 108. Each of the operating system 105, trace data graphing software 106, trace data 108 (or some combination thereof) may include elements of the programming and the trace data graphing software 106.

A user can enter commands and information into the computer 101 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 103 via a human machine interface 102 that is coupled to the system bus 113, but may be connected by other interface and bus structures, such as a parallel port, game port, or a universal serial bus (USB).

A display device 111 can also be connected to the system bus 113 via an interface, such as a display adapter 109. For example, a display device can be a monitor. In addition to the display device 111, other output peripheral devices can include components such as speakers (not shown) and a printer (not shown) which can be connected to the computer 101 via Input/Output Interface 110.

The computer 101 can operate in a networked environment using logical connections to one or more remote computing devices (not shown). By way of example, a remote computing device can be a personal computer, portable computer, a server, a router, a network computer, a peer device or other common network node, and so on.

Logical connections between the computer 101 and a remote computing device (not shown) can be made via a local area network (LAN) and a general wide area network (WAN). Such networking environments are commonplace in offices, enterprise-wide computer networks, intranets, and the Internet. In a networked environment, binary files 107, trace data graphing software 106 and trace data 108 depicted relative to the computer 101, or portions thereof, may be stored in a remote memory storage device (not shown). For purposes of illustration, application programs and other executable program components such as the operating system are illustrated herein as discrete blocks, although it is recognized that such programs and components reside at various times in different storage components of the computing device 101, and are executed by the data processor(s) of the computer.

An implementation of the and the trace data graphing software 106 may be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The exemplary Two Way Chemical Reaction Simulation System 100, shown in FIG. 1, may be utilized in conjunction with the computer and network architectures described above. The Two Way Chemical Reaction Simulation System 100 can include a general-purpose computing device in the form of a computer 101, and all subsystems of the computer 101, as previously described. The Two Way Chemical Reaction Simulation System 100 can also include, as previously described, a display device 111.

FIG. 1 illustrates a system for simulating the reaction
A+B⇄S
The chemical reaction model describing the kinetics of the reaction can be described using, for example, SBML (Systems Biology Markup Language; http://sbml.org). It is then converted by an accessory program into a hardware description language and processed in the computer 101 to generate binary files 107 that describe the digital circuit to be implemented within FPGA. The binary files 107 are downloaded to the FGPA 114 via the input/output interface 110. The present system is not limited to an FPGA, but can be any logic chip, such as PLD's (Programmable Logic Device), ASIC's (Application-Specific Integrated Circuit), or similar device, as recognized by one of skill in the art.

Within the FPGA 114, the amount, or number, of molecules of each species is kept in counters 116a,b,c indicated as blocks labeled NA, NB and Ns. For each reaction there is a set of random number generators 115a,b,c,d,e,f,g,h and comparators 118a,b,c,d,e,f,g,h that calculate the probability that the reaction moves forward by one or two reactive events.

To determine if the reaction moves forward (A+B→S), the probability that the given reaction proceeds by one or two reactive events is generated. For the reaction, there is an associated kinetic constant which can be represented by a register 117a. For example, register 117a represents the kinetic constant associated with the reaction responsible for creating molecule S from A+B. The kinetic constant register 117a has an associated random number generator 115e and an associated comparator 118e. For every simulation cycle, the reaction can occur if the number generated by the random number generator 115e is smaller than the value of the associated kinetic rate constant stored in register 117a, as determined by a comparator 118e. The comparator 118e can determine if one number is larger than another (A>B). A comparator outputs a value of “true” if the condition A>B is met. For example, the value of register 117a represents an “A” and the random number generated by the associated random number generator 115e represents a “B”. The output of comparator 118e is then provided to AND function 120c and AND function 120d, the reaction occurs if all inputs into AND function 120c or AND function 120d are true and no reaction occurs if at least one input is not true into both AND function 120c and 120d. The other inputs into AND function 120c and AND function 120d are determined by the substrates.

For each substrate (counters 116a,b) taking part in a reaction, two random number generators 115a,b, or 115c,d and two comparators 118a,b or 118c,d are assigned. It is recognized, that the system can be implemented with one random number generator associated and one comparator associated to one counter. For example, counter 116a represents the number of substrate A molecules. The counter 116a has random number generators 115a,b associated and comparators 118a,b associated. For every simulation cycle, the random numbers generated by the pair of random number generators 115a,b and 115c,d are each compared with the value, representing the number of molecules, stored in the associated counter 116a and 116b by the comparators 118a,b and 118c,d. The comparators 118a,b and 118c,d can determine if one number is larger than another (A>B). A comparator outputs a value of “true” if the condition A>B is met. For example, the value of substrate counter 116a represents an “A” and the random numbers generated by associated random number generators 115a,b each represent a “B”. The outputs of comparators 118a,b are then provided to AND function 120a and XOR function 119a. The outputs of comparators 118c,d are provided to AND function 120b and XOR function 119b. The AND function 120a can output a value of “true” if both inputs into the function is true. The AND function 120b can output a value of “true” if both inputs into the function is true. The XOR function 119a can output a value of “true” if only one input into the function is true. The XOR function 119b can output a value of “true” if only one input into the function is true. These outputs are provided to AND functions 120c,d. AND function 120c receives the output from XOR functions 119a,b. AND function 120d receives the output from AND functions 120a,b.

The forward reaction occurs by one reactive event if all inputs into AND function 120c, received from XOR functions 119a,b and comparator 118e are true. The forward reaction occurs by two reactive events if all inputs into AND function 120d, received from AND functions 120a,b and comparator 118e are true. The forward reaction does not occur if at least one input into AND functions 120c and 120d is not true. If all inputs into AND function 120c are true, the counters 116a,b are decremented by one each and the counter 116c is incremented by one. This simulates the reaction proceeding in the forward direction, losing one of each substrate molecule and gaining one product molecule. If all inputs into AND function 120d are true, the counters 116a,b are decremented by two each and the counter 116c is incremented by two. This simulates the reaction proceeding in the forward direction, losing two of each substrate molecule and gaining two product molecules.

FIG. 1 further illustrates the reverse reaction, A+B←S. The substrate of the reverse reaction is represented by a counter 116c, labeled NS and the products are represented by counters 116a,b, labeled NA and NB, respectively. To determine if the reaction moves in reverse (A+B←S), the probability that the given reaction proceeds by one or two reactive events is generated. For the reaction, there is an associated kinetic constant which can be represented by a register 117b. For example, register 117b represents the kinetic constant associated with the reverse reaction, creating molecules A and B from S. The kinetic constant register 117b has an associated random number generator 115h and an associated comparator 118h. For every simulation cycle, the reaction can occur if the number generated by the random number generator 115h is smaller than the value of the associated kinetic rate constant stored in register 117b, as determined by a comparator 118h. The comparator 118h can determine if one number is larger than another (A>B). A comparator outputs a value of “true” if the condition A>B is met. For example, the value of register 117a represents an “A” and the random number generated by the associated random number generator 115e represents a “B”. The output of comparator 118h is then provided to AND function 120f and AND function 120g, the reaction occurs if all inputs into AND function 120f or AND function 120g are true and no reaction occurs if one input is not true. The other inputs into AND function 120f and AND function 120g are determined by the reactant.

For each substrate (counter 116c) taking part in a reaction, two random number generators 115f,g and two comparators 118f,g are assigned. The counter 116c has random number generators 115f,g associated and comparators 118f,g associated. It is recognized, that the system can be implemented with one random number generator associated and one comparator associated to one counter. For every simulation cycle, the random numbers generated by the pair of random number generators 115f,g are each compared with the value, representing the number of molecules, stored in the associated counter 116c by comparators 118f,g. The comparators 118f,g can determine if one number is larger than another (A>B). A comparator outputs a value of “true” if the condition A>B is met. For example, the value of substrate counter 116c represents an “A” and the random numbers generated by associated random number generators 115f,g each represent a “B”. The outputs of comparators 118f,g are then provided to AND function 120e and XOR function 119c. The AND function 120e outputs a value of “true” if both inputs into the function are true. The XOR function 119c outputs a value of “true” if only one input into the function is true. These outputs are provided to AND functions 120f,g. AND function 120g receives the output from XOR function 119c. AND function 120f receives the output from AND function 120e.

The reverse reaction occurs by one reactive event if all inputs into AND function 120g, received from XOR function 119c and comparator 118h are true. The reverse reaction occurs by two reactive events if all inputs into AND function 120f, received from AND function 120e and comparator 118h are true. The reverse reaction does not occur if at least one input into AND functions 120f and 120g is not true. If all inputs into AND function 120g are true, the counters 116a,b are incremented by one and the counter 116c is decremented by one. This simulates the reaction proceeding in the reverse direction, losing one of the substrate molecule and gaining one of each product molecule. If all inputs into AND function 120f are true, the counters 116a,b are incremented by two and the counter 116c is decremented by two. This simulates the reaction proceeding in the reverse direction, losing two of the substrate molecule and gaining two of each product molecule.

The preceding exemplary simulation system is only one example of the contemplated systems for simulating chemical reactions. Variations in layout and equipment known to one skilled in the art are also contemplated. Another example of a simulation system is illustrated in FIG. 2.

FIG. 2 illustrates another exemplary system for simulating the kinetics of a chemical reaction. The Time Optimized One Way Chemical Reaction Simulation System 200 may be utilized in conjunction with the computer and network architectures described above. The Time Optimized One Way Chemical Reaction Simulation System 200 can include a general-purpose computing device in the form of a computer 101, and all subsystems of the computer 101, as previously described. The Time Optimized One Way Chemical Reaction Simulation System 200 can also include, as previously described, a display device 111.

FIG. 2 illustrates a system for simulating the forward reaction
A+B→S
The chemical reaction model describing the kinetics of the reaction can be described in a hardware description language and processed in the computer 101 to generate binary files 107 that describe the reaction. The binary files 107 are downloaded to the FGPA 214 via the input/output interface 110. The present system is not limited to an FPGA, but can be any logic chip, such as PLDs (Programmable Logic Device), ASIC's (Application-Specific Integrated Circuit), or similar device, as recognized by one of skill in the art.

Within the FPGA 214, the amount, or number, of molecules of each species is kept in counters 216a,b,c indicated as blocks labeled NA, NB and Ns. For each reaction there is a set of random number generators 215a,b,c,d,e,f and comparators 218a,b,c,d,e,f that calculate the probability that the reaction moves forward by one or two reactive events.

The FPGA 214 of FIG. 2 comprises a similar architecture for simulating chemical reaction kinetics as in FIG. 1. However, FIG. 2 further illustrates a system which allows for optimization of time steps. If the time step is too short, then in that short period of time the reaction will not occur most of the time. If the time step is too long, the FPGA 214 cannot take into account that multiple reactions can occur at the same time and errors will accumulate. To optimize the time step, the kinetic constant in the reaction is split into two components. The Δt dependence is separated, for all kᵢ in the simulated system according to:
kᵢ=kᵢ⁰·k_{Δt}
where kᵢ is a stochastic kinetic rate, kᵢ⁰ describes reaction specific constant and k_{Δt} is the Δt dependent part of kᵢ common to all the reactions (the time factor). Bi-directional shift register 221, representing the time factor labeled N_{Δt}, is used to adjust the overall rate of the simulation in order to optimize the rate of the most rapid reaction within the simulated system. Register 217, labeled Nₖ, represents the constant common to all reactions. Rate control module 222 is used to adjust the bi-directional shift register 221. The rate control module 222 can alternatively be implemented as a part of a program that is used to control the simulation within computer 101. The output from the system is monitored by rate control module 222 as to how fast the reactions are occurring. If the rate control module 222 determines that the simulation is running too fast, the rate control module 222 automatically adjusts the time factor contained in register 221 to slow down the reaction. Alternatively, if the rate control module 222 determines that the simulation is not running fast enough, for example, because the substrate was depleted during the previous simulation, then the rate control module 222 adjust the time factor in bi-directional shift register 221 to speed up the reaction.

For every simulation cycle, the forward reaction can occur if the number generated by the random number generator 215e is smaller than the value of the associated reaction specific kinetic rate constant stored in register 217 and the number generated by the random number generator 215f is smaller than the value of the time factor stored in bi-directional shift register 221, as determined. The comparators 218e,f can determine if one number is larger than another (A>B). A comparator outputs a value of “true” if the condition A>B is met. For example, the value of register 217 represents an “A” and the random number generated by the associated random number generator 215e represents a “B”. The outputs of comparators 218e,f are then provided to AND function 220e. The AND function 220e outputs as true if both inputs are true. The output of AND function 220e is provided to AND function 220c and AND function 220d. The forward reaction can occur if all inputs into AND function 220c or AND function 220d are true. The other inputs into AND function 220c and AND function 220d are determined by the substrates.

For each substrate (counters 216a,b) taking part in the reaction, two random number generators 215a,b or 215c,d and two comparators 118a,b or 118c,d are assigned. It is recognized, that the system can be implemented with one random number generator associated and one comparator associated to one counter. For example, counter 216a represents the number of substrate A molecules. The counter 216a has random number generators 215a,b associated and comparators 218a,b associated. For every simulation cycle, the random numbers generated by the pair of random number generators 215a,b or 215c,d are each compared with the value, representing the number of molecules, stored in the associated counter 216a or 216b by comparators 218a,b and 218c,d. The comparators 218a,b or 218c,d can determine if one number is larger than another (A>B). A comparator outputs a value of “true” if the condition A>B is met. For example, the value of substrate counter 216a represents an “A” and the random numbers generated by associated random number generators 215a,b each represent a “B”. The outputs of comparators 218a,b are then provided to AND function 220a and XOR function 219a. The outputs of comparators 218c,d are provided to AND function 220b and XOR function 219b. The AND function 220a outputs a value of “true” if both inputs into the function are true. The AND function 220b outputs a value of “true” if both inputs into the function are true. The XOR function 219a outputs a value of “true” if only one input into the function is true. The XOR function 219b outputs a value of “true” if only one input into the function is true. These outputs are provided to AND functions 220c,d. AND function 220c receives the output from XOR functions 119a,b. AND function 220d receives the output from AND functions 120a,b.

The forward reaction occurs by one reactive event if all inputs into AND function 220c, received from XOR functions 219a,b and AND function 220e are true. The reverse forward occurs by two reactive events if all inputs into AND function 220d, received from AND functions 220a,b and AND function 220e are true. The reverse reaction does not occur if at least one input into AND functions 220c and 220d is not true. If all inputs into AND function 220c are true, the counters 216a,b are decremented by one and the counter 216c is incremented by one. This simulates the reaction proceeding in the forward direction, losing one each of the substrate molecules and gaining one product molecule. If all inputs into AND function 220d are true, the counters 216a,b are decremented by two and the counter 216c is incremented by two. This simulates the reaction proceeding in the forward direction, losing two each of the substrate molecules and gaining two product molecules.

The processing of the received trace data 108 can be performed by software components. The trace data graphing software 106 may be described in the general context of computer-executable instructions, such as program modules, being executed by one or more computers or other devices. Generally, program modules include computer code, routines, programs, objects, components, data structures, etc. that perform particular tasks or implement particular abstract data types. The trace data graphing software 106 may also be practiced in distributed computing environments where tasks are performed by remote processing devices (not shown) that are linked through a communications network. In a distributed computing environment, program modules may be located in both local and remote computer storage media including memory storage devices.

The trace data graphing software 106 generates a graph of the populations of the molecules over time from the trace data 108. The trace data 108 provides information about the time evolution of the simulated system. The trace data 108 can be used, for example, for comparison with experimental data in order to evaluate a model used for simulation. The trace data 108 can also be used, for example, to measure the effects on a molecule population in varying conditions.

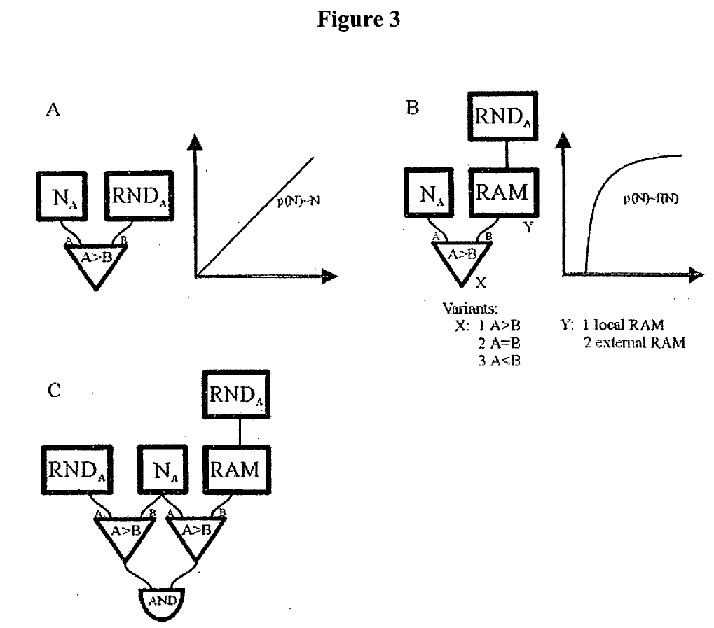

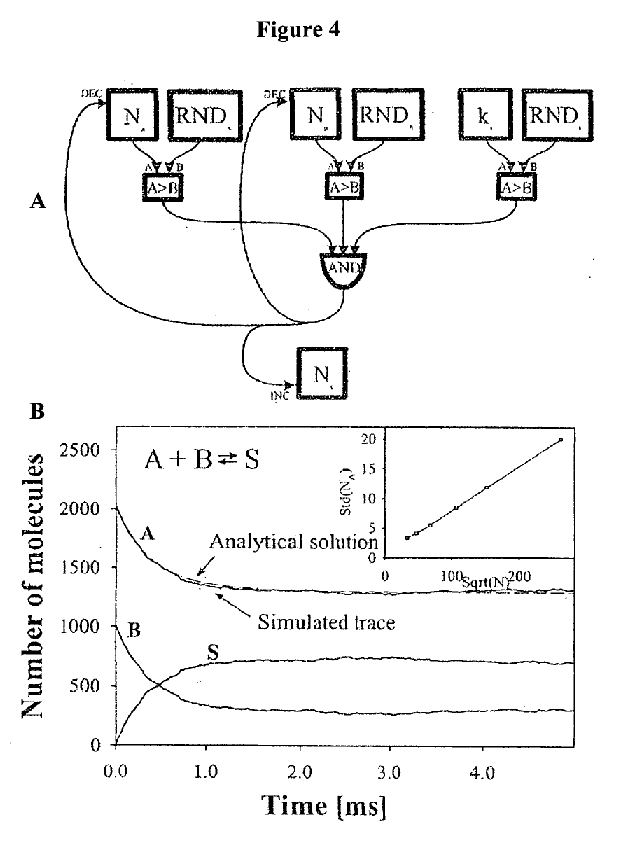

The system provides a means for realizing probabilities that are non-linear functions of the number of molecules. Those are required, for example, when modeling homodimerization (ie A+A−>A₂) reactions where the stochastic reaction rate is proportional to N_{A}(N_{A}−1) where N_{A} is the number of A molecules. FIG. 3A illustrates the use of one random number generator associated with one molecular species counter via a comparator. FIG. 3A illustrates the linearity of such a system. FIG. 3B illustrates how a random variable with a non-linear probability distribution (with respect to N) can be generated by utilizing a block of RAM (RAM can be either local to the logic chip or external; see Y variants) to store values that are drawn randomly using an address generated by a pseudo-random number generator. Those values are, in turn, compared against N_{A} to generate a random variable with distribution encoded by the contents of the RAM block. For example, filling the memory with a series: 0,1,2,3,4, . . . Nₘₐₓ will result in a probability distribution that is proportional to N−1 within the 0 . . . Nₘₐₓ range. A probability distribution of arbitrary shape can be realized by an appropriate choice of comparator function (FIG. 4B, X variants) and RAM contents. An additional degree of flexibility is possible by combining two or more blocks from 3A and 3B to realize more complicated functions. Such an approach is needed when non-monotonic functions are required (such as FIG. 3C dashed line) as the blocks in 3A and 3B can only realize probability distributions that are monotonic (i.e., non-increasing or non-decreasing within a range of interest).

### EXAMPLES

The following example is put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

### FPGA Simulation of an Elementary Bimolecular Reaction

The number of molecules of each reactive species was stored as a number within 16-bit bi-directional counters (Na, Nb, Nc) whereas constants, such as those defining the stochastic reaction rates were stored within 16-bit registers (Nk). After these were loaded with the initial values, the state of all the counters was updated, in two phases, every system clock cycle. FIG. 4A illustrates the design of the logic chip used.

Every rising edge of the clock triggered generation of a set of 16-bit random numbers by Linear Feedback Shift Register (LSFR)-based pseudo-random number generators. The generated values were then compared with the current state of the relevant counters and registers. Because the random numbers generated by distinct generators were statistically independent, the probability that each of them was smaller than the corresponding counter (register) value was:
pₜ=p(RND_{A}<N_{A},RND_{B}<N_{B}, RNDₖ<Nₖ)=a·N_{A}·N_{B}
where:
   a=Nₖ/(2¹⁶−1)³

With a proper choice of Nₖ, pₜ has the same distribution as the probability of the reaction:
A+B→S
progressing by one reactive event within a predefined short time interval.

A random variable T with pₜ distribution was readily calculated by performing a logical AND operation on the comparators' outputs. It was used to update the contents of the counters when triggered by the falling edge of the system clock. In the case of the reaction modeled here, Nₐ and N_{b} counters were incremented and N_{c} decremented by one every time T=true to reflect the occurrence of a single reactive event.

FIG. 4B shows the simulated time course of this simulation. The simulated traces (solid lines) agree well with the analytical solution of the deterministic differential equation (dashed lines). The solid traces reveal the magnitude of the stochastic fluctuations. These scale, as expected, as the square root of the system size (inset).

### Example 2

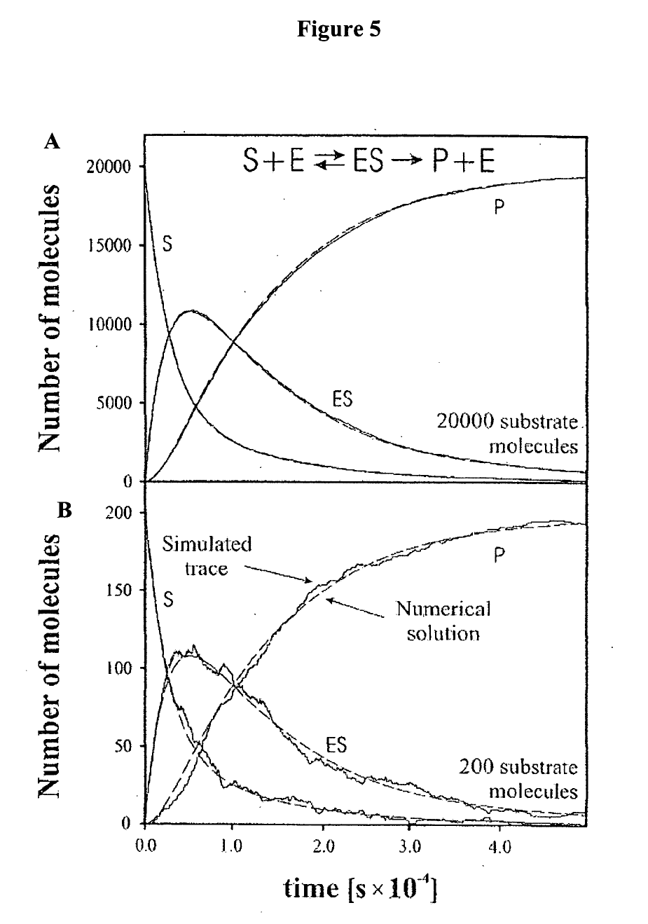

### Stochastic Simulation of the Michealis-Menten Kinetics

Whereas time evolution of the above reaction can be analyzed analytically, behavior of systems even slightly more complex, such as enzymatic reactions described by Michealis-Menten equations have to be simulated numerically even when the size of the system justifies deterministic description of the system. FIG. 5 shows time courses generated by an FPGA circuit simulating simple Michaelis-Menten kinetics of enzymatic reaction (S—substrate, P—product, E—free enzyme, ES—enzyme-substrate complex) for a system of 200 molecules (FIG. 5A) and another of 20,000 molecules (FIG. 5B). The simulated traces generated for the 20,000 molecule system closely follow the deterministic solution of the corresponding set of coupled kinetic equations whereas the 200 molecule system reveals pronounced stochastic fluctuations around the deterministic values (dashed curves). For systems of both large and small size, the simulated traces (solid lines) agreed well with the numerical solution (dashed lines) of the deterministic differential equations describing Michealis-Menten kinetics, whereas the magnitude of the observed fluctuations scales with the square root of the system size, as expected (not shown).

### Example 3

### Stochastic Simulation of the lacZ Gene Expression

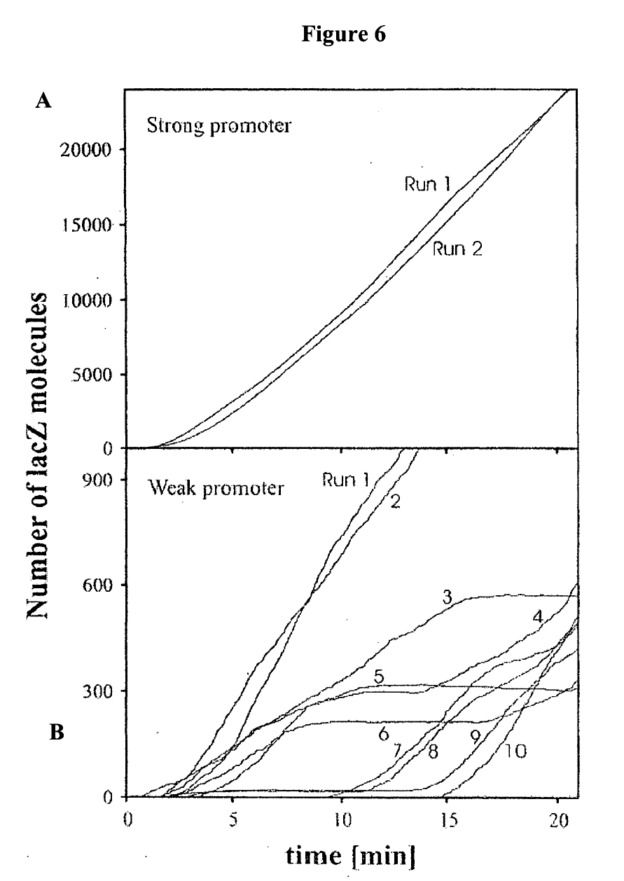

A simplified model of lacZ expression was implemented within an FPGA. It was composed of 11 coupled reactions involving 12 distinct reactive species. The traces generated during FPGA-implemented simulation (FIG. 6) show good qualitative agreement with the results of a Gillespie-based simulation. Notice that despite a significant increase of the system complexity, its entire state has been updated every clock cycle, as in the preceding examples. Most notably, at low induction strength, pronounced stochastic fluctuations of the protein synthesis rate are easily observed.

Dynamics of the model were simulated at two levels of promoter strength. FIG. 6 shows how the amount of the synthesized protein changed during independent runs (2 traces for the strong (FIG. 6A) and 10 for the weak promoter (FIG. 6B)). There was a drastic increase of the noise level for the weak promoter case, qualitatively in agreement with the results of the simulations with the Gillespie algorithm.

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for simulating the kinetics of a chemical reaction describing at least one product and at least one substrate, the reaction having a reaction specific rate constant, the method comprising:
programming a logic chip wherein each substrate, product, and reaction specific rate constant of the chemical reaction is represented by a register having a value, each substrate and reaction specific rate constant register having an associated number generator; and
tracking values of at least one of the registers over time.

2. The method of claim 1 wherein the step of tracking values of the registers over time further comprises:
generating random numbers with the number generators;
comparing the random numbers generated by the number generators with values of the registers associated with the number generators; and
updating the values of the substrate registers and the values of the product registers.

3. The method of claim 2 wherein the step of updating the values further comprises:
decrementing values of the substrate registers and incrementing values of the product registers if the number generators associated with the substrate registers generate numbers smaller than the values of the substrate registers, and the number generator associated with the reaction specific rate constant register generates a number smaller than the value of the reaction specific rate constant register.

4. The method of claim 2 further comprising programming the logic chip wherein a time factor associated with the reaction specific rate constant is represented by a register having a value, the register having an associated number generator.

5. The method of claim 4 wherein the step of updating the values further comprises:
decrementing values of the substrate registers and incrementing values of the product registers if the number generators associated with the substrate registers generate numbers smaller than the values of the substrate registers, the number generator associated with the reaction specific rate constant register generates a number smaller than the value of the reaction specific rate constant register, and the number generator associated with the time factor register generates a number smaller than the value of the time factor register.

6. The method of claim 1, further comprising outputting the results of the simulation to an output device.

7. The method of claim 1, further comprising retrieving the chemical reaction simulation model from a database.

8. The method of claim 2, further comprising monitoring the values of the registers and adjusting the value of a rate control module to adjust the rate of reaction.

9. A logic chip for simulating the kinetics of a chemical reaction describing at least one product and at least one substrate, the reaction having a reaction specific rate constant with an associated time factor, the logic chip comprising:
registers representing the substrate, product, reaction specific rate constant, and time factor of the chemical reaction; and
at least one number generator associated with each substrate register, at least one number generator associated with the reaction specific rate constant register, and at least one comparator associated with each number generator.

10. The logic chip of claim 9 wherein the logic chip is coupled to a computer.

11. The logic chip of claim 9 wherein the logic chip is programmed to perform the steps comprising:
generating random numbers with the number generators;
comparing the random numbers generated by the number generators with values of the registers associated with the number generators; and
updating the values of the substrate registers and the values of the product registers.

12. The logic chip of claim 11 wherein the step of updating the values further comprises:
decrementing values of the substrate registers and incrementing values of the product registers if the number generators associated with the substrate registers generate numbers smaller than the values of the substrate registers, and the number generator associated with the reaction specific rate constant register generates a number smaller than the value of the reaction specific rate constant register.

13. The logic chip of claim 11 further comprising a time factor associated with the reaction specific rate constant represented by a register having a value, the register having an associated number generator.

14. The logic chip of claim 13 wherein the step of updating the values further comprises:
decrementing values of the substrate registers and incrementing values of the product registers if the number generators associated with the substrate registers generate numbers smaller than the values of the substrate registers, the number generator associated with the reaction specific rate constant register generates a number smaller than the value of the reaction specific rate constant register, and the number generator associated with the time factor register generates a number smaller than the value of the time factor register.

15. The logic chip of claim 9, wherein the logic chip comprises a field programmable array (FPGA).

16. The logic chip of claim 9, wherein the substrate and product registers are 16-bit bi-directional counters, and the reaction specific rate constant register is a 16-bit register.

17. The logic chip of claim 9, further comprising outputting the results of the simulation to an output device.

18. The logic chip of claim 9, further comprising retrieving the chemical reaction simulation model from a database.

19. The logic chip of claim 13, wherein the time factor register is a 16-bit bi-directional shift register.
